(19) United States
(12) Patent Application Publication
(10) Pub. No.: US 2018/0058664 A1
(43) Pub. Date: Mar. 1, 2018

(54) Omni-directional LED Lamps

(71) Applicant: KUN-YUAN CHIANG, Taipei (TW)

(72) Inventor: KUN-YUAN CHIANG, Taipei (TW)

(21) Appl. No.: 15/252,276

(22) Filed: Aug. 31, 2016

(51) Int. Cl. F21V 9/08; F21V 23/00; F21V 23/06; F21V 3/02; F21V 9/16; F21V 15/015

(52) U.S. Cl. CPC F21V 9/08; F21V 23/001; F21V 23/06; F21Y 2115/10; F21V 9/16; F21V 15/015; F21V 3/02

(57) ABSTRACT

Provided is an omni-directional LED lamp including a lamp tube. The lamp tube includes an LED light source contained therein. In one embodiment, the LED light source includes at least one omni-directional LED lamp bar. Loose and light-permeable ceramic granule materials are filled into the lamp tube in a space between an inner wall of the tube and the LED light source. The loose light-permeable ceramic granule materials are coated on and contact to the irregular surface of the light source so as to reduce the thermal resistance and increase the heat conduction. Light diffuse reflection effects caused among the ceramic granules are positive that they can soften the light, reduce glaring and dazzling and prevent the blue light from leaking-out.

### CROSS-REFERENCE TO RELATED APPLICATIONS

This application claims the benefit of Taiwan Invention Patent Application No. TW 104137668 filed Nov. 16, 2015 that is a Utility Patent Application of Taiwan Utility Model Application No. TW 104218326 filed Nov. 16, 2015, both of which are hereby incorporated by reference.

### FIELD OF THE INVENTION

The invention relates to an LED lamp and, especially to an omni-directional LED lamp. Light permeable ceramic granule materials can be filled in a space between an inner wall of the lamp and a LED light source so as to reduce the thermal resistance, to soften the light and to prevent the blue light from leaking-out.

### BACKGROUND OF INVENTION

The LED filament lamp made from the omni-directional LED lamp bar (generally called LED filament) became more interested in the markets recently. However, in past few years, because the heat dissipation problem of the LED filament lamp was not conquered so that the cost and efficacy of it was not consistent with the expectation of markets. Thus, the market for the LED filament lamp still has not been opened. In the beginning, to overcome the heat dissipation problem, most of the LED filament lamps available in the market are heat-dissipated by sealing the opening with filling the helium gas. Comparing with the thermal conductivity of air, to fill with the helium gas will promote the thermal conductive ability more than six times. Unfortunately, the LED filament lamp has to tolerate the high temperature during flam machining and the manufacturing art for it has a very low defect-free rate. In fact, the thermal conductivity of helium gas is only 0.159 W/m.K. Therefore, now, to overcome the problem of thermal conductivity deficiency found in the glass lamp filled with helium gas, the LED drive current for the LED filament lamp available in the market is reduced by half.

Generally, the thermal conductivity of the transparent resin adhesive after hardening is about 0.3 W/K.m. Though the transparent resin adhesive may be poured and filled into the omni-directional LED lamp bar directly so as to widen the heating surface of the light emitting diode light bar during working, the etiolation of transparent resin adhesive will impact the life of LED goods. Additionally, the chemical incompatibility of the resin adhesive may cause adverse effects in which the most obvious ones include blue light, dark blue light and white light LED derived therefrom. One designer has to consider his design as sufficiently as possibly so as to maximally reduce the mutual affections among the chemicals, especially the resin adhesive poured and filled into the LED. If the resin adhesive is used without choice, adhesives that have good compatibility and high weather resistance shall be selected and, thus the manufacturers will suffer the high cost manufacturing problem resulted from the high priced materials used.

In order to enforce the heat-dissipation ability of the omni-directional LED lamp bar, the transparent substrate assorted therewith has been changed from the cheap glass plate into the expensive single crystal alumina (generally called sapphire) ceramic substrate having good heat dissipation. Additionally, to emphasize the good heat dissipation advantage of the sapphire ceramic substrate, the phosphor layer originally coated all over the transparent substrate is substituted with the one coated only on the upper and lower sides of the sapphire ceramic substrate so as to expose the left and right sides of the sapphire ceramic substrate to increase the heat dissipation ability. However, for white lighting caused by adding the phosphor layer onto the blue light LED, a problem of blue light leaking out of the right and left sides is found. Additionally, because mechanical strength of the sapphire ceramic is better than the glass and the sapphire ceramic is more expensive, the thickness of the sapphire ceramic substrate is intentionally reduced. As a result, the omni-directional LED lamp bar made with the sapphire ceramic substrate is very fragile. Furthermore, in order to resist the environment factors including rust and oxidation by moist and sulfide, the omni-directional LED lamp bar assorted with the sapphire ceramic substrate has to be arranged into a lamp tube to meet the practical need of use. Thus, the problems including reduction of the thermal resistance between the lamp tube inner wall and LED light source, softening of light, and leaking of blue light, shall be conquered.

### SUMMARY OF INVENTION

One object of the present invention is to provide an omni-directional LED lamp capable of reducing the thermal resistance and preventing leaking-out of the blue light.

The heat conductivities for common light permeable mediums include 0.0316 W/m.K for hot air, 0.18 W/m.K for helium gas, 0.25 W/m.K for plastic, 0.3 W/m.K for epoxy resin, and 0.5 W/m.K for silicone. In addition, the heat conductivities for common ceramic mediums include 1.1 W/m.K for glass, 1.5 W/m.K for quartz glass, 46 W/m.K for single crystal alumina, 28 W/m.K for polycrystalline alumina, 1.8 W/m.K for zirconia, 126 W/m.K for silicon carbide, 27 W/m.K for silicon nitride, 40 W/m.K for boron carbide, 30 W/m.K for boron nitride and 160 W/m.K for aluminum nitride.

The term “ceramic” generally refers to metallic oxides, or oxides, carbides and nitrides of non-metallic materials, for example, potassium oxide, sodium oxide and silicon oxide. The glass, a mixture including potassium oxide, sodium oxide, silicon oxide and so on, is also a kind of ceramic material. The ceramic materials that have high temperature resistance, high heat conductivity without chemical incompatibility to LED are advantageous in the application to LED for light permission and heat conduction, in which the light permeable ceramic materials are especially good.

The dry and loose granule materials that have low friction and good mobility among granules are, under a suitable vibration, closely filled into a space between the lamp tube inner wall and the light emitting diode light source. During the filling process, the dry and loose granule materials, like the moving sands in an hourglass, will cover the light emitting diode light source. In one embodiment, this is very important for the fragile omni-directional LED lamp bar. At first, to fill the granules that are moving will not cause damage by a mechanic friction or pressure on the omni-directional LED lamp bar surface. Secondly, the expansion and contraction of the omni-directional LED lamp bar upon working will not be limited by the granules coated thereon so as to prevent damage from the fatigue caused by stress.

The loose light permeable ceramic granule materials that are filled between the tube inner wall and the LED light source have a porosity that is negative to the heat conductivity of granules, and is positive to the sizes of granules. And, the sizes of the light permeable ceramic granules are positive to the light transmittance rate. Therefore, though the granules are small in size, low in porosity, high in heat conductivity, they are poor in light transmission. In view of the above, for the granule size, a calculated equivalent volume diameter of more than 0.05 mm is selected because granules having a size less than 0.05 mm are poor in light transmission. Further, because a high porosity will cause poor heat conductivity, the loose light permeable ceramic granule materials that are filled between the tube inner wall and the light source are requested to have a porosity less than 50%.

The porosity is negative to the heat conductivity, but the porosity is positive to the light permeable ceramic granule size that is positive to the light transmission. Thus, in one embodiment of the invention, a suitably adjusted granule size that can satisfy the requests for both light transmission and heat conduction is disclosed. In one embodiment, for the glass granules of different in sizes, the porosities of granules after being filled under vibration are respectively as follows:

porosity of 0.3 for granule diameter of 0.05 mm,
porosity of 0.33 for granule diameter of 0.1 mm,
porosity of 0.38 for granule diameter of 0.6 mm, and
porosity of 0.4 for granule diameter of 2.0 mm.
In one embodiment, the porosities each for mixed granules of different sizes are listed as follows:
porosity of 0.21 for diameters of 0.05 mm (22.7 wt %)+0.6 mm (77.3 wt %),
porosity of 0.24 for diameters of 0.1mm (17.8 wt %)+0.6 mm (82.2 wt %), and porosity of 0.32 for diameters of 0.6 mm (11.6 wt %)+2.0 mm (88.4 wt %).
In view of the above, to fill the mixed granules having different sizes will have a porosity smaller than the porosities caused by filling single large-sized or small-sized granules, and still can maintain the light transmission obtained by filling the large-sized granules.

Forms of granules will affect the friction among granules, while the smaller the friction is, the higher the mobility is. The friction among granules is positive to the granule repose angle. The repose angles for granules are respectively listed as follows: 23° to 28° for spherical granule, 30° for regular granule, 35° for irregular granules, and 40° for extremely irregular granule. Based on the above, in one embodiment of the invention, under the same calculated diameter of the equivalent volume granule, the use of spherical granule will achieve a lower porosity. The loose light-permeable ceramic granule materials coating on and contacting to the irregular surface of the LED lamp bar, with the contacting among neighboring granules and low porosity, may reduce thermal resistance and increase heat conduction.

In one embodiment of the invention, the phosphor layer assorted to the sapphire ceramic substrate is coated on the upper and lower sides of the substrate. Owing to the refraction and the diffusion effects of the incident light and the more uniform light-mixed effect between the LED lighting and the phosphor layer, both caused by the loose light permeable ceramic granule material, the omni-directional LED lamp bar that is exposed on the two sides of the substrate may increase the color-rendering index, reduce color temperature, soften the light, reduce dazzling and glaring and prevent the blue light from leaking out.

The viscosity among granules will affect the friction. If liquid mucosa existing among moist granules, the friction among the granules will increase and the mobility during filling will reduce. In case that the mobility is reduced, the mold pressing or high pressured injection is requested during the filling process of the granules. This will cause damages by mechanic friction and pressure on surface for the fragile omni-directional LED lamp bar. In addition, this will affect the porosity of the granules filled between the lamp tube inner wall and the LED light source. Because of the liquid mucosa, the neighboring granules will not directly contact to each other so as to enlarge the porosity and increase the thermal resistance. Thus, it is necessary to clean (with suitable oil) and then to dry the loose light permeable ceramic granules before they are filled between the inner wall and the light source.

To fill, among granules, liquids or colloids that have a refractive index similar to that of the light-permeable ceramic granules may increase the transmittance among the granules. However, a preferred method for increasing the transmittance is: at first, to fill into the space between the lamp tube inner wall and the LED light source the light-permeable ceramic granule materials that have a porosity less than 50% and allow the contacting among the neighboring granules to occur, and, then to pour the liquids or colloids that have a similar refraction index among the granules. Unfortunately, the application life of goods made by the above methods will be adversely affected owing to the chemical incompatibility and yellowing of the liquids or the colloids. In addition, although the transmittance may be increased by filling into the granules the liquids or the colloids that have similar refractive index to that of the light-permeable ceramic granules, some positive effects, such as softening light, reducing glaring and dazzling and avoiding leaking of blue light, may be adversely affected because that the diffusion and refraction effects among the loose light-permeable granule materials decrease.

In view of the above, one objective of the invention is to provide an omni-directional LED lamp. The omni-directional LED lamp contains a lamp tube having an opening end or two opening ends. There is a LED light source received in the lamp tube. The LED light source has at least two electrically connected wires respectively led out of the tube through one of the two opening ends where the lamp tube is two-opening-ended, or jointly led out of the tube through the opening end where the lamp tube is one-opening-ended. The opening end(s) is/are closed by a plug(s).

In the above mentioned omni-directional LED lamp, the LED light source has at least one omni-directional LED lamp bar. The omni-directional lamp bar has multiple LED chips including blue light LED chips and chips of other colors.

Between the inner wall of the lamp tube and the LED light source (light emitting diode light source), loose light-permeable ceramic granule materials are filled. Neighboring granules in the loose light permeable ceramic granule materials can contact to each other and the porosity of the materials is less than 50%. The loose light permeable ceramic granule materials include essential ceramic granules, sealing granules and scrappy granules. The loose light permeable ceramic granules respectively have a calculated equivalent volume granule diameter including: more than 0.1 mm for the essential ceramic granules, more than 0.05 mm and less than 0.1 mm for the sealing ceramic granules and less than 0.05 mm for the scrappy ceramic granules. And, of the loose light permeable ceramic granules, said essential ceramic granules have a volume ratio of more than 60%, said sealing ceramic granules have a volume ration of less than 40% and said scrappy ceramic granules have a volume ratio of less than 20%. During the filling procedure, the different-sized essential ceramic granules, sealing ceramic granules and scrappy granules may be fed separately and continuously with a suitable ratio at the same time. When they are filled in the lamp tube, a rotating blade is used to stir and mix the granules. In the procedure of filling the loose light permeable ceramic granules and/or in the procedure of vibrating the lamp tube after a quantitative filling, the vibration modes include linear vibration and torsional vibration. Neighboring granules of the loose light-permeable ceramic granule materials can contact each other and it means: the loose light-permeable ceramic granule materials fall down and pile up between the light tube inner wall and the LED light source and the coordinate positions each of the granules is randomly distributed so as to form a static granule supporting structure under a dense accumulation. Neighboring granules in such a static granule supporting structure will contact to each other to form a contacting with supporting relationship among neighboring granules.
In the above mentioned omni-directional LED lamp, the lamp tube includes transparent and colored lamp tubes.
In the above mentioned omni-directional LED lamp, the lamp tube is made of a material selected from a group consisting of plastic material, glass material and ceramic material.
In the above mentioned omni-directional LED lamp, the lamp tube is made of the glass material including quartz glass, soda glass, lime glass, potash glass, lead glass, borosilicate glass or mixture thereof, or the glass material includes a mixed glass material manufactured by mixing two or more than two metallic oxides or non-metallic oxides.
In the above mentioned omni-directional LED lamp, the lamp tube is made of the ceramic material including single crystal alumina and polycrystalline alumina.
In the above mentioned omni-directional LED lamp, the loose light permeable ceramic granule materials are selected from a group consisting of transparent granules and colored granules. The colors of the colored granules include red, orange, yellow, green, blue, purple or mixed color thereof.
In the above mentioned omni-directional LED lamp, the loose light permeable ceramic granules have a form selected from a group consisting of regular form and irregular form.
In the above mentioned omni-directional LED lamp, the loose light permeable ceramic granule materials are selected from a group consisting of single crystal alumina granules and polycrystalline alumina granules.
In the above mentioned omni-directional LED lamp, the loose light permeable ceramic granules are glass granules. The glass granules include quartz glass granules, soda glass granules, lime glass granules, potash glass granules, lead glass granules, borosilicate glass granules or mixture thereof, or the glass material granules include mixed glass material granules manufactured by mixing two or more than two metallic oxide materials or non-metallic oxide materials.
Comparing with prior art LED lamps, the invention has advantages as follows:
In the omni-directional LED lamp tube of the invention, the loose light-permeable ceramic granule materials cover and contact to the irregular surface of the LED light source so as to reduce the thermal resistance and to increase heat conduction. In addition, the light diffusion and fraction effects among the loose light permeable ceramic granule materials are positive, that is, they can soften the light, reduce glaring and dazzling and prevent the blue light from leaking out.

### BRIEF DESCRIPTION OF DRAWINGS

FIG. 1a is a schematic view of the LED light source in accordance with the first and the second embodiments of the invention: an omni-directional LED lamp bar having a phosphor layer.

FIG. 1b is a cross-sectional view of the LED light source in accordance with the first and the second embodiments of the invention: an omni-directional LED lamp bar having a phosphor layer.

FIG. 2a is a schematic view of the first embodiment in accordance with the invention.

FIG. 2b is a cross-sectional view of the first embodiment in accordance with the invention.

FIG. 2c is a partial enlarged view of the first embodiment in FIG. 2b.

FIG. 3a is a schematic view of the second embodiment in accordance with the invention.

FIG. 3b is a cross-sectional view of the second embodiment in accordance with the invention.

FIG. 3c is a partial enlarged view of the second embodiment in FIG. 3b.

FIG. 4a is a schematic view of the LED light source in accordance with the third and the fourth embodiments of the invention: an omni-directional LED lamp bar without phosphor layer.

FIG. 4b is a cross-sectional view of the LED light source in accordance with the third and the fourth embodiment of invention: an omni-directional LED lamp bar without phosphor layer.

FIG. 5a is a schematic view of the third embodiment in accordance with the invention.

FIG. 5b is a cross-sectional view of the third embodiment in accordance with the invention.

FIG. 5c is a partial enlarged view of the third embodiment in FIG. 5b.

FIG. 6a is a schematic view of the fourth embodiment in accordance with the invention.

FIG. 6b is a cross-sectional view of the fourth embodiment in accordance with the invention.

FIG. 6c is a partial enlarged view of the fourth embodiment in FIG. 6b.

FIG. 7a is a schematic view of the LED light source in accordance with the fifth embodiment of the invention: an omni-directional LED lamp bar having a widen substrate and the die-bonding face having no phosphor layer.

FIG. 7b is a cross-sectional view of the LED light source in accordance with the fifth embodiment of the invention: an omni-directional LED lamp bar having a widen substrate and the die-bonding face having no phosphor layer.

FIG. 8a is a schematic view of the fifth embodiment in accordance with the invention.

FIG. 8b is a cross-sectional view of the fifth embodiment in accordance with the invention.

FIG. 8c is a partial enlarged view of the fifth embodiment in FIG. 8b.

FIG. 9 is a schematic view showing the light diffusion and refraction effects caused by the light-permeable ceramic granule materials.

### DETAILED DESCRIPTION OF INVENTION

For better understanding of the technology, objectives and effects according to the invention, embodiments in accordance with the invention are described accompanying with the drawings in the followings.

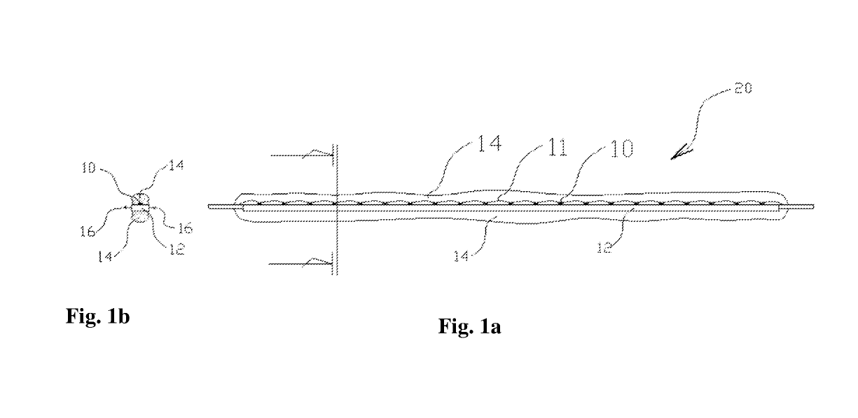

FIG. 1a and FIG. 1b, respectively are a schematic and cross-sectional view of the LED light source in accordance with the first and the second embodiments of the invention: an omni-directional LED lamp bar having a phosphor layer. The omni-directional LED lamp bar includes a phosphor layer 20. Multiple LED chips 10 are respectively die bonded or wire bonded 11 on the upper or lower side of a sapphire ceramic substrate 12. The multiple LED chips 10 include blue light LED chips and except for the blue light, other colored chips. The phosphor layers 14 are respectively coated on the upper and the lower sides of the sapphire ceramic substrate 12 so that the left and the right sides of the sapphire ceramic substrate 12 are exposed to the environment to enlarge the heat-dissipation ability. For the white lighting caused by adding the phosphor layers to the blue light LED, problems of blue-light-leaking 16 out of the left and the right sides of the substrate are derived.

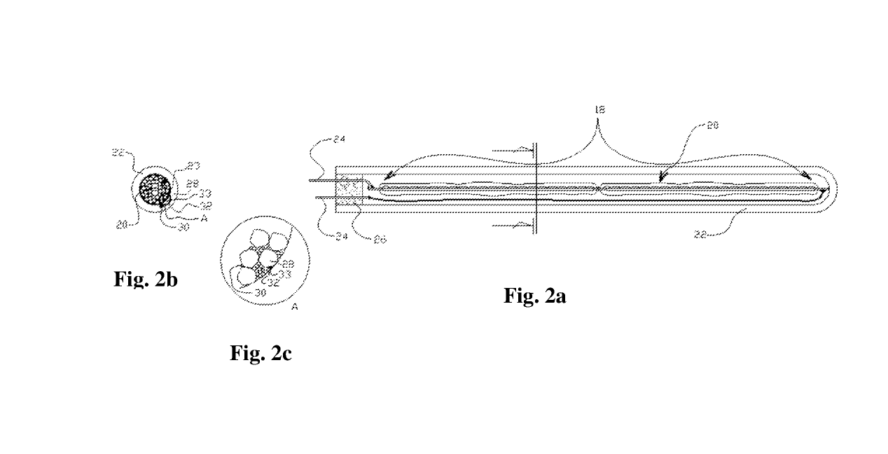

FIG. 2a is a schematic view of the first embodiment in accordance with the invention and FIG. 2b is a cross-sectional view of the first embodiment in accordance with the invention. FIG. 2c is a partially enlarged view showing the area A in the cross-sectional view of FIG. 2b. The lamp tube 22 has an opening end closed by a plug 26. The one-opening-ended lamp tube 22 contains an LED light source 18 therein. The LED light source 18 has at least two electrically connected wires 24 jointly led out of the lamp tube through the opening end. The one-opening-ended lamp tube 22 includes plastic tube, glass tube and ceramic tube. The one-opening-ended lamp tube 22 includes transparent tube or colored tube (that is dyed tube). In the first embodiment, the LED light source 18 includes two series-connected omni-directional LED lamp bars and a phosphor layer 20. In the space between the inner wall 23 of the lamp tube 22 and the LED light source 18, loose and light-permeable ceramic granule materials are filled. Neighboring granules of the loose light permeable ceramic granule materials can contact 30 to each other. The contacting 30 among neighboring granules of the loose light permeable ceramic granule materials means that the loose light-permeable ceramic granule materials fall down and pile up between the light tube inner wall 23 and the LED light source 18 wherein the coordinate positions each of granules is randomly distributed so as to form a static granule supporting structure under a dense accumulation and wherein the neighboring granules in the static granule supporting structure may contact to each other to form a supporting-relationshiped contacting. Besides, the porosity in the loose light permeable ceramic granule materials is requested to be less than 50%. If the porosity in the loose light permeable ceramic granule materials is more than 50%, the reduction of thermal resistance and the increase of heat conduction will be harmed. The loose light permeable ceramic granule materials include essential ceramic granules 28, sealing granules 32 and scrappy granules 33. The loose light permeable ceramic granules each have a calculated equivalent volume granule diameter as: more than 0.1 mm for the essential ceramic granules 28, more than 0.05 mm and less than 0.1 mm for the sealing ceramic granules 32 and less than 0.05 mm for the scrappy ceramic granules 33. And, of said loose light permeable ceramic granules, the essential ceramic granules 28 have a volume ratio of more than 60%, the sealing ceramic granules 32 have a volume ration of less than 40% and the scrappy ceramic granules 33 have a volume ratio of less than 20%. During the filling procedure, the different-sized essential ceramic granules 28, sealing ceramic granules 32 and scrappy granules 33 may be fed separately and continuously with a suitable ratio at the same time. When they are filled in the one-opening-ended lamp tube 22, a rotating blade may be used to stir and mix the granules. In the procedure of filling the loose light permeable ceramic granules and/or in the procedure of vibrating the one-opening-ended lamp tube 22 after a quantitative filling of granules, the vibration modes include linear vibration and torsional vibration. The contacting 30 of neighboring granules in the loose light-permeable ceramic granule materials includes the neighbored contacting of the neighboring granules with the same or different sizes including the essential ceramic granules 28, sealing ceramic granules 32 and the scrappy granules 33. The essential ceramic granules 28 are used to reduce the thermal resistance and to increase the heat conduction. In addition, the diffusion and refraction effects by the essential granules are positive to soften the light and prevent the blue light from leaking out. The sealing ceramic granules 32 are used as a supplementary to reduce the porosity so as to reduce the thermal resistance and to increase the heat conduction. However, the addition of the sealing ceramic granule 32 will reduce the transmittance of the loose light-permeable ceramic granule materials. The scrappy ceramic granules 33 are dust particles adhering on the surface of the essential ceramic granules 28 or the sealing ceramic granules 32. Besides, during transporting or filling, the vibration will impact on the essential ceramic granules 28 and the sealing ceramic granules 32 to cause the fragmentation of granules into the scrappy ceramic granules 33. The scrappy ceramic granules 33 are the less the better, because the light diffusion and refraction effects by them are too great to favor the transmittance of light.
The light permeable ceramic granule materials include the transparent granules and the colored granules.
The granule forms of the light-permeable ceramic granule materials include a regular form of light-permeable ceramic granule and an irregular form of light-permeable ceramic granule. The regular-formed light-permeable ceramic granules include spherical, bead-formed and symmetric-cube-formed light permeable ceramic granules. The irregular-formed light-permeable ceramic granules include piece-like, plate-like and asymmetric-cube-formed light permeable ceramic granules.
In one embodiment, the light-permeable ceramic granule materials include single crystal alumina ceramic or polycrystalline alumina ceramic granules.
In one embodiment, the light permeable ceramic granules are glass granules. The glass granules include quartz glass granules, soda glass granules, lime glass granules, potash glass granules, lead glass granules, borosilicate glass granules or mixture thereof, or the glass material granules includes mixed glass material granules manufactured by mixing two or more than two metallic oxide materials or non-metallic oxide materials.

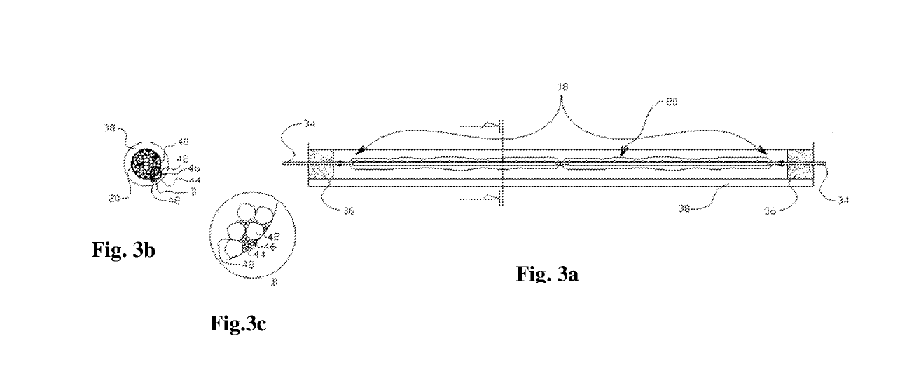

FIG. 3a is a schematic view of the second embodiment in accordance with the invention and FIG. 3b is a cross-sectional view of the second embodiment in accordance with the invention. FIG. 3c is a partially enlarged view showing the area B in the cross-sectional view of FIG. 3b. In the second embodiment, the LED light source is the same as the one in the first embodiment. The second embodiment is different from the first embodiment in terms of the lamp tube patterns. In the second embodiment, two ends of the two-opening-ended lamp tube 38 are closed respectively by a plug 36. (That is, if the lamp tube has two opening ends, both of the two openings are closed by the plugs 36; and if the lamp tube has only one opening end, the opening of the tube is closed by the plug 26). The two-opening-ended lamp tube 38 receives a LED light source 18 contained therein. The LED light source 18 includes two series-connected omni-directional LED lamp bars and a phosphor layer 20. The LED light source 18 includes two electrically connected wires 34 each led out of the two-opening-ended lamp tube 38 through one of the two opening ends thereof. In the space between the lamp tube inner wall 40 and the LED light source 18, loose and light-permeable ceramic granule materials are filled. Neighboring granules of the loose and light-permeable ceramic granule materials may contact 48 to each other. The light-permeable ceramic granule materials include the essential ceramic granules 42, the sealing ceramic granules 44 and the scrappy ceramic granules 46.

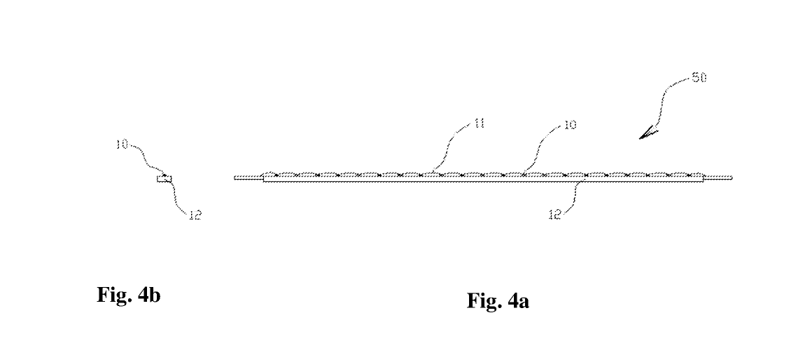

FIG. 4a is a schematic view of the LED light source in accordance with the third and fourth embodiments of the invention and FIG. 4b is a cross-sectional view of the LED light source in accordance with the third and fourth embodiments of the invention showing an omni-directional LED lamp bar without phosphor layer. The non-phosphor-layer-containing omni-directional LED lamp bar 50 includes multiple LED chips 10 respectively die-bonded or wire-bonded 11 on one of the upper and the lower sides of the sapphire ceramic substrate 12. The multiple LED chips 10 include blue light LED chips and other colored LED chips. The sapphire ceramic substrate 12 is not covered by a phosphor layer so as to expose its upper, lower, left and right sides to the environment to increase the heat dissipation ability. However, for white lighting of the blue light LED, the remote phosphor layer is made on the outer or inner wall of the lamp tube.

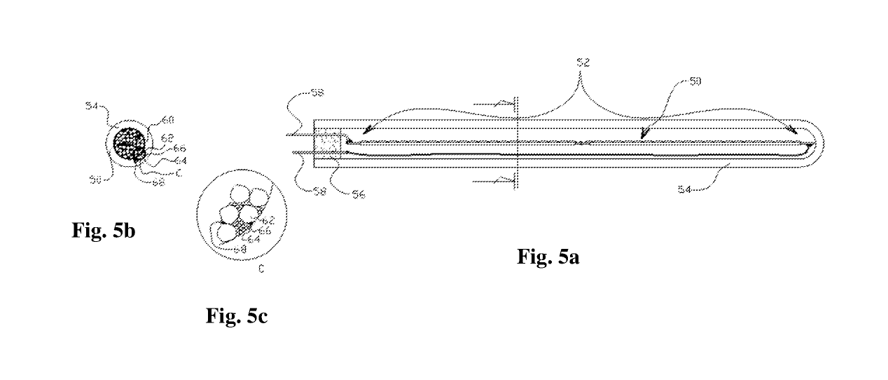

FIG. 5a is a schematic view of the third embodiment in accordance with the invention and FIG. 5b is a cross-sectional view of the third embodiment in accordance with the invention. FIG. 3c is a partially enlarged view showing the area C in the cross-sectional view of FIG. 5b. The third embodiment differs from the first embodiment in that: the LED light source 52 is composed of two series-connected omni-directional LED lamp bars 50 without phosphor layer. Because the sapphire ceramic substrate 12 is not covered by the phosphor layer, its upper, lower, left and right sides are exposed to the environment so as to contact to the loose light-permeable ceramic granule materials to increase the heat dissipation ability. In this embodiment, for the white lighting of blue-light LED tube, a remote phosphor layer is coated on the inner wall 60. The one-opening-ended lamp tube 54 includes a plug 56 to close its opening. The one-opening-ended lamp tube 54 also includes an LED light source 52 having at least two electrically connected wires 58 jointly led out of the lamp tube through the opening. Loose and light-permeable ceramic granule materials are filled into the space between the lamp tube inner wall 60 and the LED light source 52. Similarly, neighboring granules of the light-permeable ceramic granule materials may contact 68 to each other. The light permeable ceramic granule materials include essential ceramic granules 62, sealing ceramic granules 64 and scrappy ceramic granules 66.

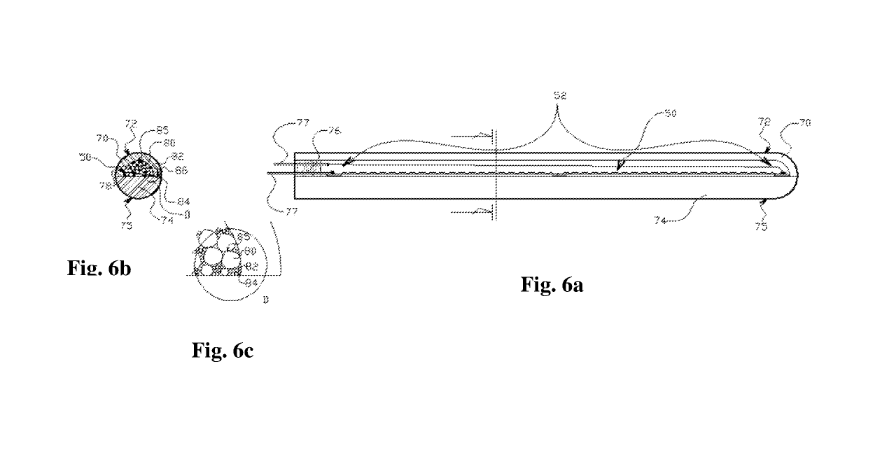

FIG. 6a is a schematic view of the fourth embodiment in accordance with the invention and FIG. 6b is a cross-sectional view of the fourth embodiment in accordance with the invention. FIG. 6c is a partially enlarged view showing the area D in the cross-sectional view of FIG. 6b. The fourth embodiment is similar to the third embodiment in terms of the LED light source, but they are different in the lamp tube patterns. In this embodiment, a one-opening-ended lamp tube is constructed by a semi-circular cover 70 and a semi-circular solid rod 74. The LED light source 52 includes two series-connected omni-directional LED lamp bars and includes no phosphor layer. For the LED light source 52 including the omni-directional lamp bar but no phosphor layer 50, the sapphire ceramic substrate 12 is adhered on the die-bonding surface 86 of the solid semi-circular rod 74. The semi-circular cover 70 and the semi-circular solid rod 74 may be manufactured by glass, single crystal alumina or polycrystalline alumina so as to increase the heat conduction. In this embodiment, the one-opening-ended lamp tube includes a plug 76 to close its opening. This one-opening-ended lamp bar includes an LED light source 52 inside. The LED light source 52 includes at least two electrically connected wires 77 jointly led out of the lamp tube through the opening of the tube. In this embodiment, in the space between the lamp tube inner wall and the LED light source, loose and light permeable ceramic granule materials may be filled. That is, the loose and light-permeable ceramic granule materials are filled between the LED light source 52 and the lamp tube inner wall that is constructed by the inner wall 78 of the semi-circular cover 70 and the die-bonding surface 86 of the semi-circular solid rod 74. The contacting 85 of neighboring granules in the loose light-permeable ceramic granules is found. The light-permeable granule materials include essential granules 80, sealing granules 82 and scrappy granules 84. However, in this embodiment, for white lighting of the blue-light LED, a remote phosphor layer is manufactured on the outer semi-circular wall 72 of the semi-circular cover 70 and on the outer circular wall 75 of the semi-circular solid rod 74.

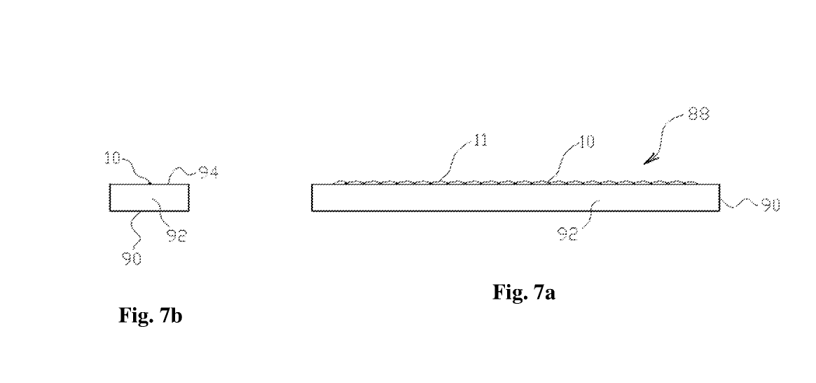

FIG. 7a and FIG. 7b respectively are a schematic and cross-sectional view of the LED light source in accordance with the fifth embodiment of the invention: an omni-directional LED lamp bar having a widen substrate and no phosphor layer on the die-bonding surface. The substrate-widened omni-directional LED lamp bar 88 includes a die-bonding surface 94 not coated with a phosphor layer. Multiple LED chips 10 are die-bonded or wire-bonded 11 on the die-bonding surface 94 of the ceramic substrate 92 and the die-bonding surface 94 is not covered by phosphor layer. The multiple LED chips 10 include blue-light LED chips and LED chips emitting other colors. The ceramic substrate 92 includes glass, single crystal alumina and polycrystalline alumina so as to increase the heat conduction.

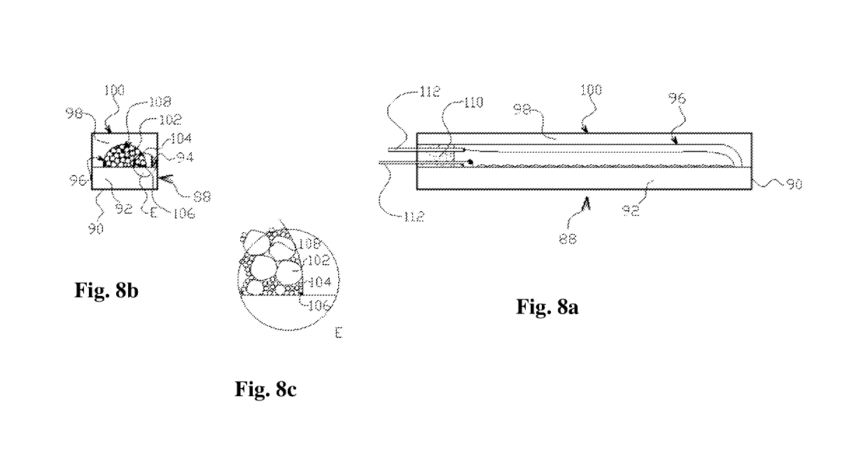

FIG. 8a is a schematic view of the fifth embodiment in accordance with the invention and FIG. 8b is a cross-sectional view of the fifth embodiment in accordance with the invention. FIG. 8c is a partially enlarged view showing the area E in the cross-sectional view of FIG. 8b. The fifth embodiment differs from the first embodiment in terms of the LED light source and the tube patterns. In this embodiment, the LED light source is a substrate-widened omni-directional LED lamp bar 88 without phosphor layer coated on the die-bonding surface. A one-opening-ended lamp tube is constructed by the substrate-widened omni-directional LED lamp bar 88 having no phosphor layer on the die-bonding surface and a semi-circular ditch cover 98. In this embodiment, the one-opening-ended lamp tube includes a plug 110 to close the opening. The one-opening-ended lamp tube includes an LED light source therein and a substrate-widened omni-directional LED lamp bar 88 having no phosphor layer on the die-bonding surface. The substrate-widened omni-directional LED lamp bar 88 that has no phosphor layer on its die-bonding surface includes at least two electrically connected wires 112 jointly led out of the tube through the only one opening of the tube. In this embodiment, light-permeable loose ceramic granule materials are filled between the lamp tube inner wall and the LED light source. The lamp tube inner wall includes the substrate-widened omni-directional LED lamp bar 88 that has no phosphor layer on its die-bonding surface, the die-bonding surface 94 of the ceramic substrate 92, and the inner ditch wall 96 of the semi-circular ditch cover 98. The contacting 108 of neighboring granules in the loose light-permeable ceramic granules is found. The light-permeable granule materials include essential granules 102, sealing granules 104 and scrappy granules 106. The ceramic substrate 92 and the semi-circular ditch cover 98 respectively are made of glass and single crystal alumina or polycrystalline alumina to benefit heat conduction. For the white-lighting of the blue-light LED, a remote phosphor layer is made on the outer surface 100 of the semi-circular ditch cover 98 and the outer surface 90 of the ceramic substrate 92.

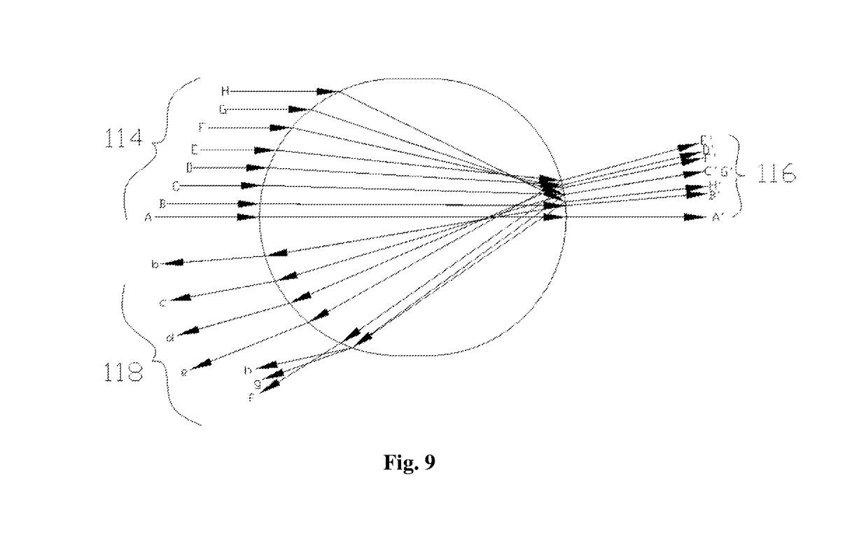

FIG. 9 is a schematic view showing the light diffusion and refraction effects by the light-permeable ceramic granule materials. The incident light 114 enters into the light-permeable ceramic granule materials, and then part of the light 114 penetrates it to become diffuse refraction light 116 and the other part of the light 114 reflects to become diffuse reflection light 118. For the omni-directional LED lamp bar 20 (having phosphor layer) discussed in the first and the second embodiments, the phosphor layer 14 is coated on the upper and lower sides of the sapphire ceramic substrate 12 so as to expose both of the left and right sides of the substrate 12 to increase the heat dissipation ability and to allow the blue light to leak out 16. The blue light leaking-out 16 is similar to the incident light 114 entering the light permeable ceramic granule materials, that is, part of the blue light penetrates the materials and then becomes into diffuse refraction light 116 and has a changed outgoing angel so as to mix with the white light to prevent the blue light from leaking out, while the other part of it internally reflects to become the diffuse reflection light 118 that then enters into the phosphor layer 14 to become mixed light so as to increase the color rendering index and reduce color temperature. In the third, fourth and fifth embodiments, the light diffuse reflection effects caused by the light permeable ceramic granule materials can soften the light, reduce glaring and blazing. The incident light 114 includes several different parallel incident rays respectively entering into a light-permeable granule at different positions each indicated by the captioned letters: A, B, C, D, E, F, G and H. The captioned letters each of A′, B′, C′, D′, E′, F′, G′ and H′ are the outgoing angels of the corresponding rays when leaving out of the light-permeable ceramic granule. And, the letters a, b, c, d, e, f, g and h respectively are the different diffuse reflecting rays of the diffuse reflecting light 118 caused by the reflection of the incident light 114 after its entering into the light-permeable granules.

The above descriptions are used to schematically explain the embodiments in accordance with the invention but for the limitation of the invention. Equivalent changes and amendments, made by those skilled in the art without departing from the spirits and the principles of the invention, all fall into the scope of the following claims.

1. An omni-directional LED lamp, characterized by said omni-directional LED lamp comprising a lamp tube including one or two opening ends and an LED light source contained therein;
said LED light source including at least two electrically connected wires, said at least two electrically connected wires respectively being led out of each one of said two opening ends where said lamp tube is two-opening-ended and said wires being jointly led out of said one opening end where said lamp tube is one-opening-ended;
said two opening ends each being closed by a plug where said lamp tube is two-opening-ended and said one opening end being closed by a plug where said lamp tube is one-opening-ended;
loose light-permeable ceramic granule materials being filled into a space between an inner wall of said lamp tube and said LED light source, and wherein neighboring granules of said loose light-permeable ceramic granule materials are able to contact to each other such that said loose light permeable ceramic granule materials have a porosity of less than 50%;
said loose light permeable ceramic granule materials including essential ceramic granules, sealing ceramic granules and scrappy ceramic granules, and said loose light permeable ceramic granule materials including several calculated equivalent volume diameter for granules: more than 0.1 mm for said essential ceramic granules; more than 0.05 mm and less than 0.1 mm for said sealing ceramic granules; and less than 0.05 mm for said scrappy ceramic granules; and
for said loose light permeable ceramic granule materials, said essential ceramic granules having a volume ratio of more than 60%, said sealing ceramic granules having a volume ration of less than 40% and said scrappy ceramic granules having a volume ratio of less than 20%.

2. The omni-directional LED lamp of claim 1 characterized by, the LED light source including at least one omni-directional LED light bar, the omni-directional LED light bar including multiple LED chips, and the multiple LED chips including blue light LED chips and LED chips having other colors.

3. The omni-directional LED lamp of claim 1 characterized by, the lamp tube including transparent and colored lamp tubes.

4. The omni-directional LED lamp of claim 1 characterized by, the lamp tube being made of a material selected from a group consisting of plastic material, glass material and ceramic material.

5. The omni-directional LED lamp of claim 4 characterized by, the lamp tube being made of the glass material, and the glass material including quartz glass, soda glass, lime glass, potash glass, lead glass, borosilicate glass or a mixed glass made of any two glass materials listed above, or the glass material including a mixed glass material manufactured by mixing two or more than two metallic oxides or non-metallic oxides.

6. The omni-directional LED lamp of claim 4 characterized by, the lamp tube being made of the ceramic material, and the ceramic material including single crystal alumina and polycrystalline alumina.

7. The omni-directional LED lamp of claim 1 characterized by, the loose light permeable ceramic granule materials being selected from a group consisting of transparent granules and colored granules.

8. The omni-directional LED lamp of claim 1 characterized by, the loose light permeable ceramic granules having a form being selected from a group consisting of regular form and irregular form.

9. The omni-directional LED lamp of claim 1 characterized by, the loose light permeable ceramic granule materials being selected from a group consisting of single crystal alumina granules and polycrystalline alumina granules.

10. The omni-directional LED lamp of claim 1 characterized by, the loose light permeable ceramic granules being glass granules, the glass granules including quartz glass granules, soda glass granules, lime glass granules, potash glass granules, lead glass granules, borosilicate glass granules or a mixture of two granules listed above, or the glass material granules including mixed glass material granules manufactured by mixing two or more than two metallic oxide materials or non-metallic oxide materials.
